(19) United States
(12) Patent Application Publication
(10) Pub. No.: US 2007/0091556 A1
(43) Pub. Date: Apr. 26, 2007

(54) Module assembly for locking and unlocking a battery of an electronic device

(75) Inventor: Yaz-Tzung Wu, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/253,694

(22) Filed: Oct. 20, 2005

(51) Int. Cl. G06F 1/16

(52) U.S. Cl. 361/683

(57) ABSTRACT

The present invention is to provide a module assembly for locking and unlocking a battery of an electronic device, which including a receiving groove deposited at a lower chassis having a first and a second limit section on both sidewalls; wherein an automatic latch button deposited on the first limit section and a passive latch button deposited on the second limit section both comprise a latch with an embedding hole, a button body, a lock tongue and an extended rod body, a flange is disposed on the rod body of the automatic latch button for connecting an elastic element, a flange is disposed on the rod body of the passive latch button for pressing against at least one protrusion on the second limit section, one side of each button body is exposed from the lower chassis, and an embedding body is disposed on another side of each button body to be latched into the embedding hole of each latch.

### FIELD OF THE INVENTION

The present invention relates to a module assembly for locking and unlocking a battery of an electronic device, and more particularly to a module assembly disposed at the lower chassis of an electronic device (e.g. notebook), which having an automatic latch button and a passive latch button for locking and unlocking.

### BACKGROUND OF THE INVENTION

In recent years, the computer industry is blooming, and the notebook computer technology is improved constantly by engineers and gradually appreciated by consumers. As the price of notebook computers drops year after year, notebook computers are used extensively. Unlike the desktop computers offering different brands and models for consumer's choice, notebook computers sacrifice the possibility of upgradeability. However, the lightweight, thin, short and compact design of notebook computers has advantages over the desktop computers, and their mobility and convenience is incomparable by desktop computers.

In general, notebook computers are divided into two types: one type of notebook computers includes a built-in optical disk drive and floppy disk drive and weighs about 3 Kg and thus involving a heavier burden for users to carry and providing more convenient functions and applications; and the other type of notebook computers is connected externally to an optical disk drive or a floppy disk drive, and thus its weight drops to 2 Kg, which is more convenient for carrying the computer. However, the functions and applications of this type of notebook computers are not as good as the previous type.

At present, a lithium (Li-ion) battery is mainly used as the battery for notebook computers, since the lithium battery does not have a memory property. The so-called memory property refers to a chemical memory property that is produced when the battery is charged repeatedly to a specific electric capacity. Therefore, the battery charge cannot exceed such the specific electric capacity no matter how the battery is charged at a later date. The lithium battery does not have such a problem, and it provides high electric capacity and comes with a small volume. Therefore, the lithium battery is a favorite battery adopted by most manufactures, and most of the present notebook computers are using this kind of batteries.

Traditionally, the battery of a notebook computer is designed as a rectangular insertable battery, but the rectangular insertable battery must correspond to two embedding latch buttons installed at a lower chassis of the notebook computer, and the two embedding latch buttons are provided for locking or unlocking the rectangular insertable battery; wherein one embedding latch button is designed as an automatic latch button, and the other embedding latch button is designed as a passive latch button that requires a user to push the button by hands. These two latch buttons are used for locking and unlocking the battery. If the passive latch button is set in a locked status, then switching the automatic latch button cannot remove the rectangular insertable battery.

If a user wants to remove the rectangular insertable battery from a receiving groove at the lower chassis of the notebook computer, the user has to simultaneously switch the two embedding latch buttons (including the automatic latch button and the passive latch button) disposed at the backside of the lower chassis, so that the two embedding latch buttons can be separated from an embedding hole of the rectangular insertable battery, and the battery can be removed from the receiving groove successfully.

Referring to FIGS. 1 and 2 for the schematic views of the interior and exterior of an automatic latch button and a passive latch button of the present invention, a receiving groove 11 is disposed at a lower chassis 10 of a notebook computer as shown in FIG. 1. The receiving groove 11 is provided for embedding a rectangular insertable battery 20, and a guiding groove 21 and an embedding hole 22 are disposed on both sidewalls of the rectangular insertable battery 20, and a guiding track 12 is disposed separately on two corresponding sidewalls of the receiving groove 11. The two guiding tracks 12 are provided for guiding the guiding grooves 21 of the rectangular insertable battery 20. The lower chassis 10 installs the internal components of an automatic latch button 13 and a passive latch button 14 respectively on two corresponding sides of the receiving groove 11 as shown in FIGS. 1 and 2. The automatic latch button 13 comprises a latch 15 and a button body 16 and is limited in a limit section 17 inside a lower chassis 10, and an end of the latch 15 includes a rod body 151 coupled to an end of a spring 152, and the other end of the spring 152 presses against another end of the limit section 17, such that the automatic latch button 13 can be shifted to have an automatic reciprocal movement. Further, the button body 16 is latched into an embedding hole 153 on the latch 15 by an embedding body 161 of the button body 16 (as shown in FIG. 2) to constitute the automatic latch button 13.

Further, the passive latch button 14 also comprises a latch 15′ and a button body 16′ and is limited into another limit section 18 inside the lower chassis 10. An elastic arm 154 is installed separately on both sides of an end of the latch 15′, and a flange 155 is disposed on a free end of each of the two elastic arms 154, and the two flanges 155 press against at least one protrusion 181 disposed on two corresponding sides of another end of another limit section 18, such that the passive latch button 14 is used for manually locking and unlocking a battery. The button body 16′ is latched into an embedding hole 153′ of the latch 15′ by an embedding body 161′ on the button body 16′ to constitute the passive latch button 14.

Therefore a user just needs to operate the automatic latch button 13 and passive latch button 14 to separate the other ends of the two latches 15, 15′ (as shown in FIG. 1, and only the numeral 156 can be seen in the figure) from the embedding hole 22 of the rectangular insertable battery 20 and successfully remove the rectangular insertable battery 20 from the receiving groove 11.

From the description above, it is clear that the automatic latch button 13 and the passive latch button 14 of the lower chassis 10 of the notebook computer are composed of two different types of components, and thus the persons skilled in the art understand that it is necessary to have a mold for manufacturing each of the automatic latch button 13 and passive latch button 14, which will causes a high cost. In the meantime, the processes planning material, and managing materials and inventory will become more complicated, and even worse, the assembler may have difficulties of determining the materials or make mistakes easily.

The foregoing component design of the automatic latch button 13 and the passive latch button 14 no longer can meet the present requirements, and their shortcomings are the actual problems encountered by current notebook computer manufacturers in the manufacture and assembling of the notebook computers. Viewing from the worldwide distributions and sales of notebook computers, we understand that if the manufacturers cannot effectively overcome the foregoing shortcomings, they cannot gain a good market share in the severe competition, and thus their market competitiveness will drop.

In summation of the above description, electronic products are substantially of the same quality. Without a good design to improve the foregoing shortcomings, a manufacturer hardly can succeed, and thus finding a way to improve the prior art and the competitiveness demands immediate attentions.

### SUMMARY OF THE INVENTION

In view of the description above, the inventor of the present invention based on years of experience to conduct extensive researches and experiments to improve the prior art and finally invented a module assembly for locking and unlocking a battery of an electronic devices in accordance with the present invention.

Therefore, it is a primary objective of the present invention to overcome the foregoing shortcomings of the two different types of components including the automatic latch button and passive latch button at the lower chassis of a prior art notebook computer. The notebook computer includes a receiving groove disposed at the lower chassis, and the interior of the lower chassis includes a first limit section and a second limit section disposed on both sidewalls adjacent to the receiving groove; wherein the first limit section includes an automatic latch button comprised of a latch and a button body, and the second limit section includes a passive latch button comprised of a latch and a button body, and these two latches include an embedding hole each, and a lock tongue is installed at an end of the two latches and exposed from both ends of the receiving groove. A rod body is extended horizontally from the other end of the two latches; wherein a flange is disposed on the external edge of the rod body of the automatic latch button for connecting an elastic element, and a flange is disposed on the external edge of the rod body on the passive latch button, such that the flange presses against at least one protrusion on another end of the second limit section, and one side of the two button bodies is exposed from the lower chassis, and an embedding body is disposed on another surface of the two button bodies to be latched into the embedding hole of the two latches. Therefore, the components of the automatic latch button and the passive latch button constitute a common module assembly, not only reducing the quantity of molds to effectively lower the manufacturing cost, but also simplifying the material planning, material management and inventory by the common module assembly.

The above and other objects, features and advantages of the present invention will become apparent from the following detailed description taken with the accompanying drawings.

### BRIEF DESCRIPTION OF THE DRAWINGS

FIG. 1 is a schematic view of the exterior of an automatic latch button and a passive latch button on a lower chassis of a notebook computer according to a prior art;

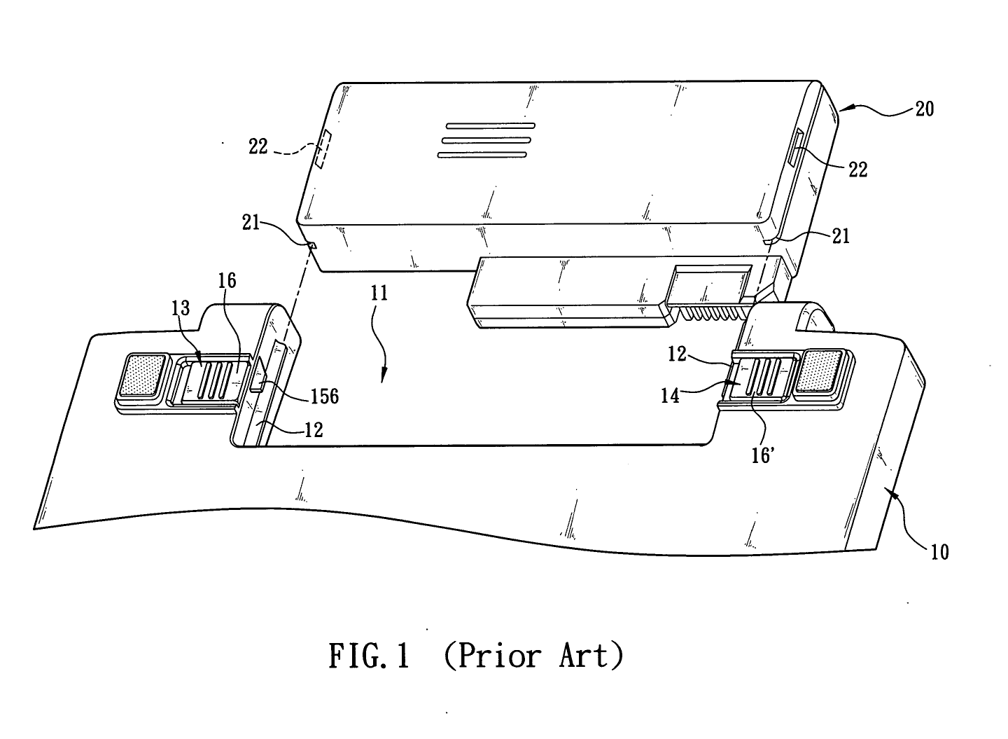

FIG. 2 is a schematic view of the interior of an automatic latch button and a passive latch button on a lower chassis of a notebook computer according to a prior art;

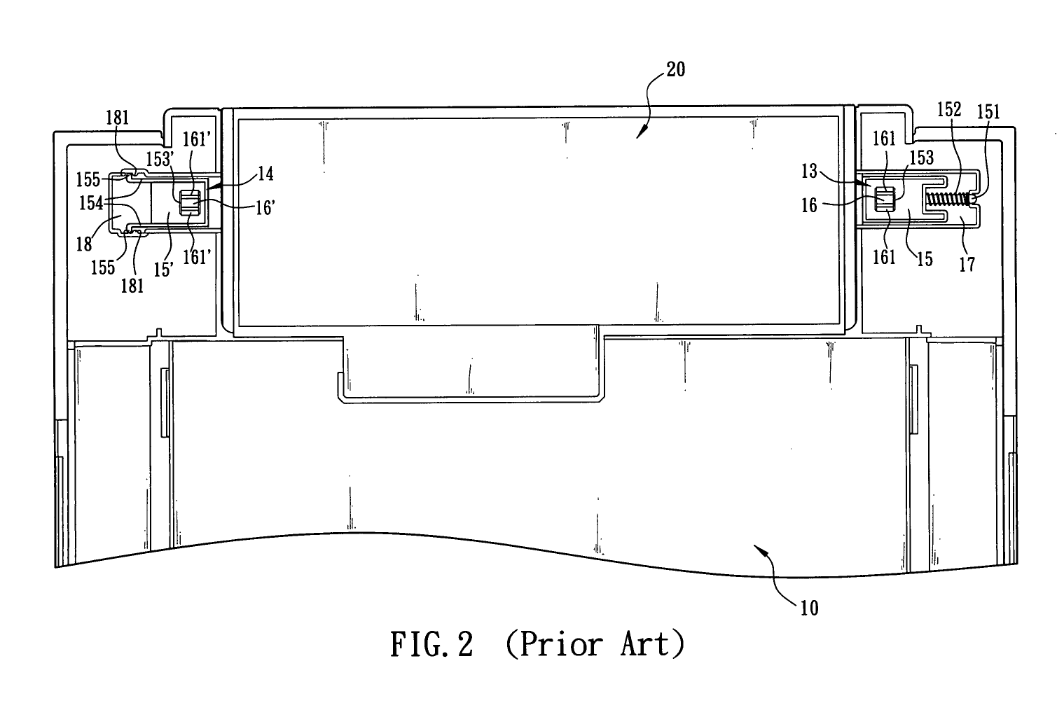

FIG. 3 is a schematic view of the interior of a module assembly installed onto a lower chassis of a notebook computer according to the invention; and

FIG. 4 is a schematic view of the exterior f a module assembly installed onto a lower chassis of a notebook computer according to the invention.

### DETAILED DESCRIPTION OF THE PREFERRED EMBODIMENTS

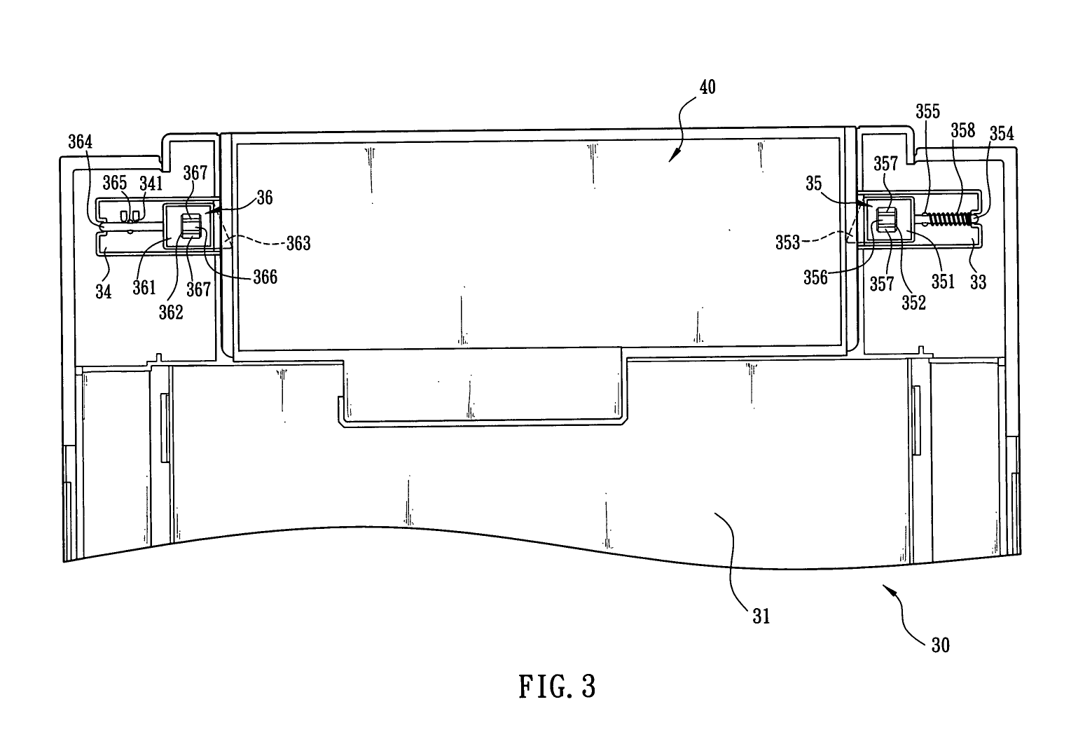

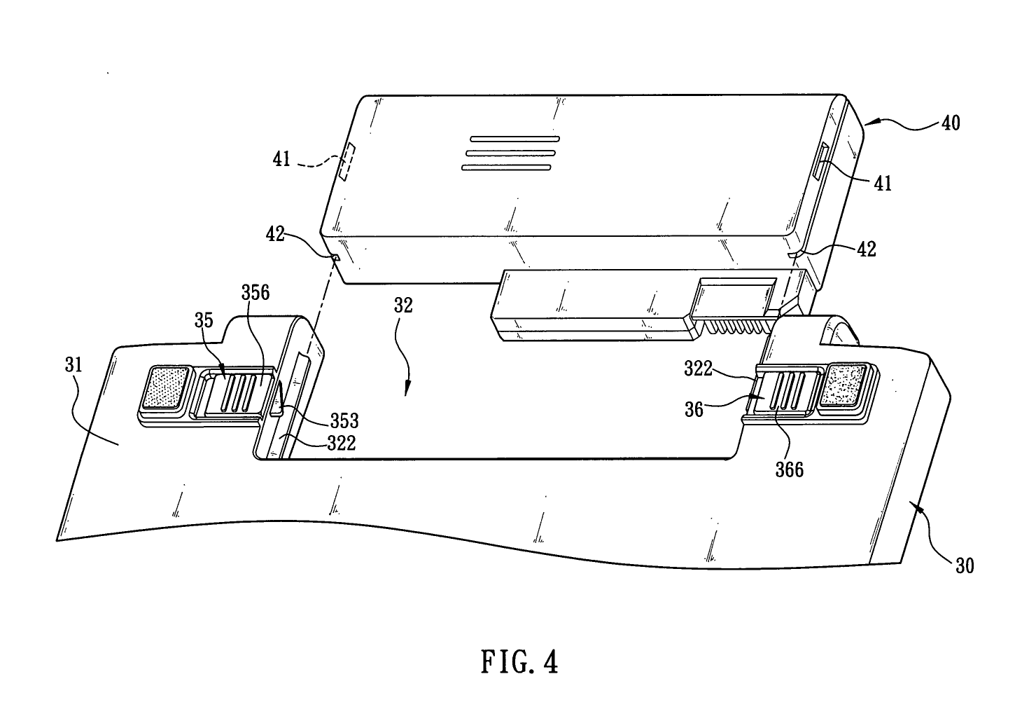

Referring to FIGS. 3 and 4 for the module assembly for locking and unlocking a battery of an electronic device according to a preferred embodiment of the present invention, an electronic device such as a notebook computer is used for illustration. The notebook computer 30 comprises a lower chassis 31, a narrow long receiving groove 32 disposed on one side of the lower chassis 31, and a first limit section 33 and a second limit section 34 separately disposed inside the lower chassis 31 and proximate to both sidewalls of the receiving groove 32 as shown in FIG. 3; wherein the first limit section 33 includes an automatic latch button 35, and the automatic latch button 35 comprises a latch 351 and a button body 356, and the latch 351 includes an embedding hole 352 thereon, and one end of the latch 351 includes an inclined lock tongue 353 exposed from an end of the receiving groove 32 and a rod body 354 extended horizontally from another end of the latch 351. The rod body 354 includes a flange 355 disposed at a specific distance from the external edge of the rod body 354, and the rod body 354 includes an elastic element 358 such as a spring disposed at the section between the free end and the flange 355, and both corresponding ends of the elastic element 358 separately press against another end of the limit section 33 and the flange 355, such that the automatic latch button 35 can resume its original position after an external force is exerted onto the automatic latch button 35 to shift the automatic latch button 35. Further, a side of the button body 356 is exposed from the exterior of the lower chassis 31 (as shown in FIG. 4). Another side of the button body 356 includes an embedding body 357 embedded into the embedding hole 352 of the latch 351 to define the automatic latch button 35.

Further, the second limit section 34 (as shown in FIG. 3) includes a passive latch button 36 therein, and the passive latch button 36 comprises a latch 361 and a button body 366, and the latch 361 includes an embedding hole 362 thereon, and one end of the latch 361 is an inclined lock tongue 363 exposed from another end of the receiving groove 32, and a rod body 364 is extended horizontally from another end of the latch 361, and a flange 365 is disposed on the rod body 364 at a specific distance from a flange 365, and the flange 365 presses against at least one protrusion 341 disposed at another end of the second limit section, such that the passive latch button 36 can manually lock and unlock a battery. A side of the button body 366 is exposed from the exterior of the lower chassis 31 (as shown in FIG. 4), and the button body 366 includes an embedding body 367 on the other side of the button body 266, and the embedding body 367 is latched into the embedding hole 362 of the latch 361 to define the passive latch button 36.

Referring to FIG. 4 again, a battery 40 can be embedded into the receiving groove 32 of the lower chassis 31, and the battery 40 includes an embedding hole 41 disposed on both distal walls of the battery 40, and the two embedding holes 41 precisely and respectively embed the inclined lock tongue 353 of the automatic latch button 35 and the inclined lock tongue 363 of the passive latch button 36 as shown in FIG. 3. Further, the receiving groove 32 includes a sliding track 322 disposed proximate to the inclined lock tongues 353, 363 on both corresponding distal walls. The battery 40 includes a sliding groove 42 disposed on both corresponding distal walls proximate to the embedding hole 41. With the two sliding tracks 322 and the two sliding grooves 42, the battery 40 can be embedded successfully into the receiving groove 32, so as to achieve a convenient connection.

Therefore, a user just needs to operate the automatic latch button 35 and the passive latch button 36 to separate the inclined lock tongue 353 of the automatic latch button 35 and the inclined lock tongue 363 of the passive latch button 36 respectively from the two embedding holes 41 of the battery 40 and remove the battery 40 from the receiving groove 32 successfully.

With the foregoing components, it is clear that the characteristics of the automatic latch button 35 and the passive latch button 36 are identical with the only difference that the automatic latch button 35 has the elastic element 358 installed in the section between the free end of the rod body 354 and the flange 355, such that the automatic latch button 35 can resume its original position after an external force is exerted to move the automatic latch button 35. If the elastic element 358 is not installed, then the passive latch button 36 can be used for manually locking and unlocking the battery.

Therefore, the advantages of the present invention include using the same type of mold for manufacturing the components of the automatic latch button 35 and the passive latch button 36 to achieve the purpose of producing a common module assembly, not only reducing the quantity of the two sets of molds to effectively lower the manufacturing cost, but also simplifying the material planning, material management and inventory of the module assembly. Therefore, the design of the present invention definitely improves over the prior arts.

While the invention has been described by means of specific embodiments, numerous modifications and variations could be made thereto by those skilled in the art without departing from the scope and spirit of the invention set forth in the following claims.

What is claimed is:

1. A module assembly for locking and unlocking a battery of an electronic device, comprising:
a lower chassis, having a receiving groove disposed on one side of said lower chassis, and a first limit section and a second limit section separately disposed on both sidewalls of said lower chassis proximate to said receiving groove;
an automatic latch button, being disposed in said first limit section, and said automatic latch button comprising a latch and a button body, and said latch including an embedding hole thereon, and an end of said latch being a lock tongue and exposed from an end of said receiving groove, and a rod body being extended horizontally from another end of said latch, and said rod body comprising a flange disposed on an external edge at a specific distance from said rod body, and an elastic element being disposed in a section between a free end of said rod body and said flange, and a side of said button body being exposed from the exterior of said lower chassis, and an embedding body disposed on another side of said button body, and said embedding body being latched into said embedding hole of said latch;
a passive latch button, disposed in said second limit section, and said passive latch button comprising a latch and a button body, and said latch comprising an embedding hole thereon, and an end of said latch being a lock tongue and exposed from an end of said receiving groove, and a rod body being extended horizontally from another end of said latch and a flange disposed at an external edge at a specific distance from said rod body, and said flange pressing against at least one protrusion disposed at another side of said second limit section, and one side of said button body being exposed from the exterior of said lower chassis, and said button body having an embedding body disposed on another side and said embedding body being latched into said embedding hole of said latch.

2. The module assembly for locking and unlocking a battery of an electronic device of claim 1, wherein said receiving groove is provided for embedding a battery, and said battery includes an embedding hole disposed separately on both distal walls of said battery, and said two embedding holes are provided for embedding a lock tongue of said automatic latch button and a lock tongue of said passive latch button.

3. The module assembly for locking and unlocking a battery of an electronic device of claim 2, wherein said receiving groove comprises a sliding track separately disposed on both corresponding distal walls proximate to said inclined lock tongue, and said battery comprises a sliding groove separately disposed on both corresponding distal walls proximate to said embedding hole.

4. The module assembly for locking and unlocking a battery of an electronic device of claim 1, wherein said lock tongue of said automatic latch button is substantially in an inclined shape.

5. The module assembly for locking and unlocking a battery of an electronic device of claim 1, wherein said lock tongue of said passive latch button is substantially in an inclined shape.
